(19) United States
(12) Patent Application Publication
(10) Pub. No.: US 2019/0219077 A1
(43) Pub. Date: Jul. 18, 2019

(54) THE RECTIFIER FOR SYMMETRICAL FLOW OF FLUID IN A PIPELINE

(71) Applicant: MALAD, S.R.O., Poprad (SK)

(72) Inventors: Ladislav ZUFFA, Poprad (SK); Martin MICHAL, Poprad (SK)

(21) Appl. No.: 16/071,205

(22) PCT Filed: Jan. 19, 2017
(86) PCT No.: PCT/SK2017/000001

§ 371 Date: Jul. 19, 2018

(30) Foreign Application Priority Data
Jan. 20, 2016 (SK) PP 003-2016

(51) Int. Cl. F15D 1/02

(52) U.S. Cl. CPC F15D 1/025

(57) ABSTRACT

The rectifier for symmetrical flow of fluid in a pipeline is formed with at least one double chamber, consisting of the expansion chamber wherein the inlet axial rectifying member is mounted which is circumferentially provided with a radial circumferential perforation and the compression chamber provided with the outlet opening, while the expansion chamber is separated from the compression chamber at least one radial rectifying member with an axial perforation, while the radial rectifying member is formed by at least one radial plate with many openings which form an axial perforation.

### TECHNICAL FIELD

The invention concerns the rectifier for symmetrical flow of fluid in a pipeline, in particular but not exclusively, the fluid flow symmetry rectifiers in high pressure piping for the remote transport of fluids.

### BACKGROUND ART

The very frequent requirement in piping systems for the transport of fluids is accurate measuring of trade transported liquids, or their exact dosage. The continuous flow measurement is carried out in various ways of measuring e.g. by means of turbine, ultrasonic flow meter etc. To achieve the high accuracy of flow rate measurement in most cases it is required to have a uniform laminar flow of fluid with a regular parabolic profile. Particularly during the transport of energy fluids such as oil and natural gas there is an emphasis on extreme precise measurement of transported fluid. The precise flow measuring in complex piping systems and systems with high flow rates is usually a significant problem because of the frequent occurrence of turbulent flow or laminar flow with different degrees of deformity of the idea! flow profile due to the spiral flow and so on. Various types of flow rectifiers are used for the purpose to direct the flow and create an appropriate flow profile. The area of flow rectifiers in piping systems for transport of liquids is relatively very well monitored. Many standard solutions of this problem are known and some patented solution are known as well. Most of rectifiers is based on a variety of perforated plates, or the set of perforated plates, which are inserted between pipe flanges or directly into the piping.

There are also various systems based on the bundle of axially extending rectifiers e.g. axial tube bundle, crossed axial stack of plates and so on. These known solutions are presented in the standards ISO rectifiers ANSI, DIN and so on as well as in the patent documents: CA2228928, EP0942220, EP1564475, WO2014110673.

These rectifiers solve the problem of laminar flow and the creating the ideal flow profile of the stream. However in some cases, the flow of fluid, especially in case of spiral flow with significant shifting of flow to the edge of piping solve this problem only partially. Another big disadvantage of rectifiers based on the principle of iris, which is inserted between pipe flanges is their high pressure loss. Shielding of these rectifiers is usually more than 50%, which subsequently generates high pressure drop on the rectifier itself. These losses need to be overcome by increased output of transport machinery for transported fluids e.g. compressors for gases, respectively pumps for liquids. When transporting materials in large gas and oil pipelines, product pipelines, or water supply, these losses represent considerable high value of the lost energy.

### DISCLOSURE OF INVENTION

These deficiencies are considerably eliminated by the rectifier for symmetrical flow of fluid in a pipeline according to this invention.

It is characterized by at least one double-chamber consisting of an expansion chamber which has expansion sub-chamber where the inlet axial rectifying member is inserted and which is fitted with circumferential radial perforations and the compression chamber equipped with the outlet opening. The overall area of the radial perforations is in most cases preferably equal to or greater than the cross section of the inlet opening. However, it may also be smaller depending on the particular use of the rectifier, and the required pressure drop. The expansion chamber is separated from the compression chamber with at least one radial rectifying member with axial perforation. The radial rectifying member is formed with at least one radial transversal multiply boring of the plate, while the plate may be formed by any permeable piate such as a plate with bored holes, a porous material, steel wool, a sieve or other similar way. The overall flow cross section of the radial-permeable surface member is preferably equal to or greater than the cross section of inlet opening. However, it may also be smaller, depending on the particular use of the rectifier, and the required pressure drop. Radial rectifying member may consist of several permeable plates arranged gradually in a row, while e.g. the sieves with various sizes of openings, wire sieves, steel wool inserted between sieves, or porous material and in any combination, or other known solutions can be used. The work of rectifier is following: The medium, e.g. natural gas at high pressure (about 6 MPa) transported in pipelines is driven into the inlet of axial rectifying member which is connected directly to the transport pipeline. The flow direction is transferred to many partial radial streamlines at the entrance of the axial rectifying member. Subsequently the expansion of each streamline occurs after passing through the wall of the axial rectifying member, and these streamlines are directed to the wall of the expansion chamber, where there is repeated change of the flow direction of the expanded streamline. This ensures the removal of any turbulent eddies or spiral flow with displaced flow profiles that formed the flow of the media in the intake piping and the equal pressure flow of the working media in the expansion chamber is designed. Subsequently, the medium is passed through the axial holes of radial rectifying member into the compression chamber, where there is a single axial alignment of streamlines by means of passing through the axial holes of radial rectifying member and subsequently compressing in the compression chamber where the compressed streamlines create an ideal parabolic profile of laminar fluid flow. Such laminar flow with ideal flow profiles guarantees ideal conditions for highly accurate measurement of the transported amount of liquids which can be used for transportation of liquids in big international gas pipelines, big pipelines, or similar industrial sites. Another important advantage of the solution is that taking into consideration the cross section of perforated holes compared to the area of the piping the rectifier according to this invention has a minimal pressure drop—much smaller than the current existing solutions. This allows to save the energy of transport machinery—e.g. compressors or pumps depending on to the transported medium.

### BRIEF DESCRIPTION OF DRAWINGS

The invention will be further explained by means of figures, where:

FIG. 1 shows the rectifier for symmetrical flow of fluid in a pipeline with removable axial rectifying member and a non-detachable double chamber with nonremovable radial member.

FIG. 2 shows the rectifier for symmetrical flow of fluid in a pipeline with nonremovable axial rectifying member and detachable double chamber and interchangeable radial rectifying member.

FIG. 3 shows the rectifier for symmetrical flow of fluid in a pipeline with removable axial rectifying member and a non-detachable double chamber in the shape of piping elbow and with non-removable radial member.

### EXAMPLES OF INVENTION IMPLEMENTATION

### Example 1

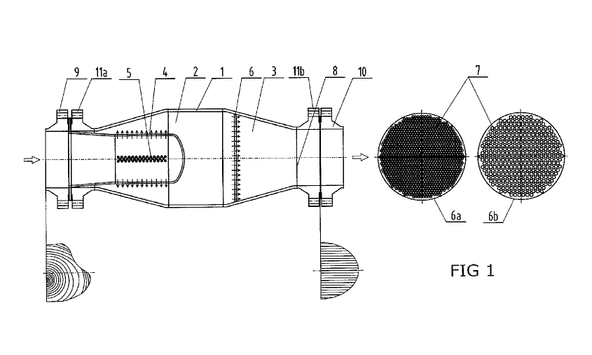

The rectifier for symmetrical flow of fluid in a pipeline is shown in FIG. 1. It is created by one double chamber 1, which consists of an expansion chamber 2 wherein which an inlet axial rectifying member 4 is fitted, which has circumferential perforation 5 and the compression chamber 3 with the outlet opening 8. In this case the overall cross-section area of the radial perforations is 1.2 times of the inlet pipe cross section. The expansion chamber 2 is separated from the compression chamber 3 with one radial rectifying member 6 with axial perforation 7. In this case the radial rectifying member 6 is formed by means of one radial plate 6a with the many openings which form an axial perforation 7. The overall permeable surface of radial rectifying member 6 is equal to 1.1 times of the inlet pipe cross-section. The rectifier is equipped with the inlet flange 1a and outlet flange 11b, which are to be fitted to flanges of the transport piping with flanges 9 and 10. This solution provides the possibility of exchanging the axial rectifying members 4 for other members with different characteristics. The simplest rectifier of this construction type with non-replaceable rectifying members can be of course equipped with welded sockets instead of inlet and outlet flanges. FIG. 1 shows the deformed flow profile of input medium below inlet flange 9 and below the outlet flange 10 the flow profile achieved after passing the rectifier is shown.

### Example 2

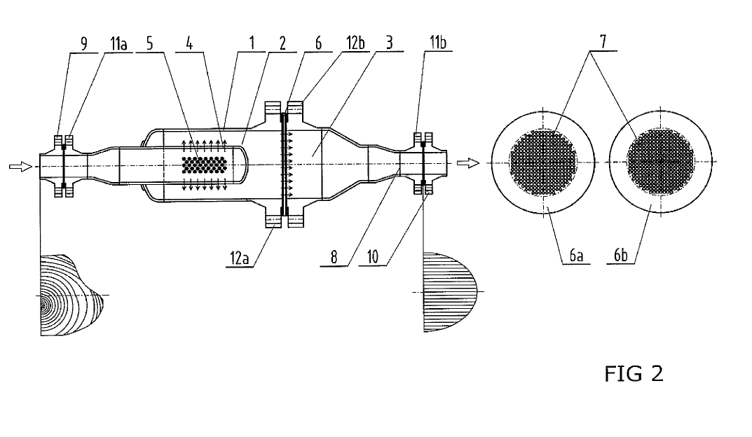

The rectifier for symmetrical flow of fluid in a pipeline is shown in FIG. 2. It is created by one double chamber 1, consisting of an expansion chamber 2 wherein which an inlet axial rectifying member 4 is fitted, which has a circumferential radial perforations 5 and the compression chamber 3 equipped with the outlet opening 8. In this case the overall area of the radial perforations is 1.0 times of the inlet pipe cross section. The double chamber is carried out as dismountable and it is equipped with flanges 12a and 12b while radial rectifying member 6 is fitted between the flanges. The expansion chamber 2 is separated from the compression chamber 3 with the radial rectifying member 6 which has axial perforation 7. In this case the radial rectifying member 6 is created from one radial plate 6a with many openings which form an axial perforation 7. The overall permeable surface of radial rectifying member 6 is equal to 1.0 times of the inlet pipe cross-section.

The demountable double chamber 1 ensures the possibility of exchanging the radial rectifying member 6, for the member with different characteristics e.g. 6b. The rectifier is equipped at its ends with the inlet flange I to and outlet flange 1i b, which are to be fitted to flanges of the transport piping 9 and 10. FIG. 2 shows the deformed flow profile of input media below inlet flange 9 and below the outlet flange 10 the flow profile achieved after passing the rectifier is shown.

### Example 3

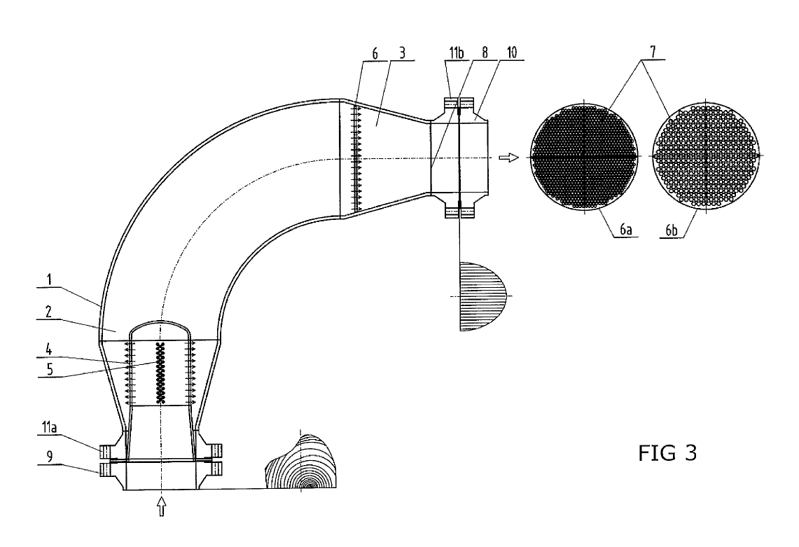

The rectifier for symmetrical flow of fluid in a pipeline is shown in FIG. 3. It is created of one double chamber 1, which consists of an elbow-shaped expansion chamber 2 wherein the inlet axial rectifying member 4 is fitted, which has circumferential perforation 5 and the compression chamber 3 with the outlet opening 8. In this case the overall cross-section area of the radial perforations is 1.2 times of the inlet pipe cross section. The expansion chamber 2 is separated from the compression chamber 3 with one radial rectifying member 6 with the axial perforation 7. In this case the radial rectifying member 6 is formed by means of one radial plate 6a with the many openings which form an axial perforation 7. The overall permeable surface of radial rectifying member 6 is equal to 1.1 times of the cross-section of the inlet pipe. The rectifier is equipped at its ends with the inlet flange Vi a and outlet flange 1i b, which are to be fitted to flanges of the transport piping 9 and 10. This solution provides the possibility of exchanging the axial rectifying member 4 for the member with different characteristics. This variant can be used in these cases where for the space or other reasons the direct rectifier cannot be used. FIG. 3 shows the deformed flow profile of input media below inlet flange 9 and below the outlet flange 10 the flow profile achieved after passing the rectifier is shown.

### INDUSTRIAL APPLICABILITY

The rectifier for symmetrical flow of fluid in a pipeline can be produced industrially and used industrially in all piping for transporting fluids including but not limited to the carriage of substances in big gas and oil pipelines, product pipelines, and water piping systems as well.

1) A rectifier for symmetrical flow of fluid in a pipeline wherein it consists of at least one double chamber, which consists of the expansion chamber wherein inlet axial rectifying member is mounted and which is circumferentially provided with a radial circumferential perforation and the compression chamber provided with the outlet opening, while the expansion chamber is separated from the compression chamber at least with one radial rectifying member with an axial perforation, while the radial rectifying member is formed with at least one radial plate with many openings which form an axial perforation.

2) The rectifier for symmetrical flow of fluid in a pipeline according to the claim 1, wherein that the radial member is formed by a system of radial plates arranged in a row and the axial perforation which is formed by the sieve and/or steel wool and/or porous matter.
